(19) United States
(12) Patent Application Publication
(10) Pub. No.: US 2007/0264416 A1
(43) Pub. Date: Nov. 15, 2007

(54) Quinoa-containing beverages and methods of manufacture

(76) Inventor: Marcus Edwards, Newport, RI (US)

Correspondence Address: ROETZEL & ANDRESS, 1375 EAST 9TH STREET, CLEVELAND, OH, 44114, US

(21) Appl. No.: 11/433,906

(22) Filed: May 15, 2006

(51) Int. Cl. A23L 1/36

(52) U.S. Cl. 426/629; 426/590

(57) ABSTRACT

Quinoa-containing beverages and methods of processing and manufacture include mechanical grinding, milling or pulverization of natural quinoa seeds to produce a quinoa ingredient for a beverage. The process includes the steps of providing washed quinoa, milling quinoa to within a specified range of particle sizes, blending milled quinoa with a liquid base such as water, and heating the blended beverage to within a specified temperature range. Additional steps may include the introduction of other compatible ingredients, and roasting quinoa seeds prior to milling or grinding. Use of automated processing equipment for commercial scale beverage production is also described.

### FIELD OF THE INVENTION

The present invention is in the general field of healthful beverages, including beverage formulations and methods of processing and manufacturing such beverages. More specifically, the invention concerns a quinoa-containing beverages and formulations and processes for making quinoa-containing beverages.

### BACKGROUND OF THE INVENTION

Quinoa is a seed of the Chenopodium plant (technically a botanical fruit) indigenous to Peru and which grows in the Andean mountains. Quinoa (Chenopodium quinoa) has been cultivated in the Andean highlands since 3000 B.C. Its adaptation to cold, dry climates, seed processing similarity to rice, and excellent nutritional qualities make quinoa a valuable crop to highland areas around the world. Quinoa is generally considered to be a single species within the Chenopodiaceae. Quinoa is used as a cereal crop, but is not a grass and has been classified as a pseudocereal. Over 120 species have been found within the genus Chenopodium. Quinoa seeds are referred to herein alternatively simply as a “quinoa”, “quinoa grain”, “quinoa seed(s)” or “quinoa beans”. The mature quinoa seed is typically about 2 mm in diameter and 1 mm thick. The nutritional value of quinoa is known to be superior to traditional cereals, and is in fact superior to milk solids in feeding trails. Protein content ranges from 10 to 18% with a fat content of 4.1 to 8.8%. Quinoa protein is also high in lysine, methionine and cystine. Quinoa also provides starch, ash, sugars, oil (high in essential linoleic acid), fiber, minerals, and vitamins Starch, ash, and crude fiber average 60.1, 4.2, and 3.4%, respectively. The ash has been found to primarily consist of potassium and phosphorus (65% of total). Calcium and iron are significantly higher in quinoa than in rice, maize, wheat, or oats. Variations have been observed between species and between landraces within species. Quinoa seeds have saponin in the seedcoat, a resin-like substance that is extremely bitter and forms a soapy solution in water. Saponin can be removed either mechanically or with a water rinse. Mechanical abrasion systems currently in use fail to remove all saponin, leaving bran with saponin attached to perisperm granules. To be edible, the saponin must be removed. Traditionally, saponin has been removed by laboriously hand scrubbing the quinoa in alkaline water. The removal of saponin from the outer shell has been one factor limiting quinoa's production and marketing. Saponins function as “antinutrients” and are frequently associated with plant lipids. They are not normally absorbed from the gut and have been shown to induce small intestinal damage or reduce intestinal absorption of nutrients.

U.S. Pat. No. 5,688,772 discloses quinoa saponin compositions for enhancing mucosal absorption for pharmaceutical applications. U.S. Pat. No. 6,355,249 discloses a process for recovery and purification of saponins and spogenins from quinoa for pharmaceutical applications.

Because quinoa has been grown for centuries under varied ecological conditions there is no “pure” strain. Quinoa is predominately an inbreeder and any given crop is composed of a mixture of inbred lines. Thus, quinoa varies greatly within a given region and from region to region. Peru and Bolivia have quinoa seed banks that total over eighteen hundred ecotype samples of quinoa.

The edible seed of the quinoa plant has been called both a pseudo-cereal and a pseudo-oilseed because of its unique nutritional profile. It is high in protein compared to other grains, although it is also high in oil and fat.

Some wheats come close to matching quinoa's protein content, but cereals such as barley, corn, and rice generally have less than half the protein of quinoa. Also, quinoa has a good balance of the amino acids that make up the protein. Quinoa is also a good complement for legumes, which are often low in methionine and cystine. In addition, quinoa is a relatively good source of phosphorous, calcium, iron, vitamin E, and several of the B vitamins.

Of equal importance as quinoa's nutritional benefits is the hardiness of this plant. Unlike most other food crops, quinoa thrives with low rainfall; high altitudes (and therefore high radiation levels); thin, cold air; hot sun; subfreezing temperatures; and even poor, sandy, alkaline soil. It is this ability to thrive where few other food crops can that has allowed quinoa to remain a staple food of millions of descendants of the Inca Empire.

Quinoa has been used in a perioperative multivitamin protein beverage and additive for use in preparing an individual for fast surgical recovery. Quinoa has also been used in beverages that can contain a fibrous component derived from quinoa beans. In the prior art, the fibrous component can be from any of a variety of origins including that of the quinoa bean. European patent EP 1 338 206 discloses a liquid product which contains an extract of tiger nut, an extract of quinoa and a mixture of enzymes of the α-amylase type.

Extract of quinoa has been used as a milk substitute to increase protein content. Additionally, protein concentrates have been made from quinoa. More particularly, the art discloses a process and composition related to isolating protein from quinoa beans using an alkaline solution rather than by mechanical processing or extraction. The prior art discloses a process including, in relevant part, the steps of defatting the quinoa beans, and extracting with an aqueous alkaline solution at room temperature. Thus, prior art processes produce a product that is separated from fiber, starch and insoluble protein.

### SUMMARY OF THE INVENTION

The present invention provides a process for making a quinoa-containing beverage or beverage component from ground, milled or pulverized quinoa beans, to provide the healthful benefits of quinoa in a beverage. The manufacturing process involves three principle steps of milling quinoa to within a specified range of particle sizes, mixing the milled quinoa with a liquid base such as water, and heating the mixed formula to within a specified temperature range for sterilization and suspension (anti-clumping) of the ground quinoa within the water base. Quinoa beans are ground or milled or otherwise pulverized to a particle size in an approximate range of from about 30 microns to 350 microns or larger, or preferably in an approximate range of from about 50 microns to 250 microns or larger, or more preferably in a range of from about 80 microns to about 150 microns or larger. The resulting quinoa powder is combined with a liquid base such as water, in a ratio range of approximately 2% to 20% quinoa to water by volume, to produce a blended quinoa-containing beverage. The beverage is heated to a temperature in a range of preferably not less than about 180 degrees F. to preferably not greater than about 212 degrees F., for an approximate time period of about 30 to 45 seconds. A related process step of the invention involves roasting of quinoa beans or grain with forced hot air to within an approximate temperature range of 450 to 460 degrees Fahrenheit for an approximate period of 14 to 21 minutes, followed by grinding or milling of the roasted quinoa grain to within the described particle size range to produce the quinoa component of a beverage formulation.

Pre-washed, substantially saponin-free quinoa seeds are ground to within the described particle range which is soluble in a sufficient quantity, preferably within an approximate range of 2% to 15% by volume, in a water or other liquid base to deliver the healthful benefits of quinoa in a drinkable beverage. For example, as further described herein, a 1 liter volume of the quinoa-containing beverage may contain from approximately 20 cc to 200 cc of ground quinoa dissolved or dispersed in a water or other liquid base with flavoring and other suitable additives, such as colorants or preservatives as desired or required. The quinoa beverage is then heated to within the described parameters for sterilization and bottled or canned, e.g. “heat filling”.

These and other aspects of the quinoa-containing beverages and methods of manufacture are further described herein, with reference to certain illustrative examples which a representative of but limiting to the different ways in which the disclosed concepts can be carried out.

### DETAILED DESCRIPTION OF PREFERRED AND ALTERNATE EMBODIMENTS

The present invention provides beverages and methods for making beverages which contain quinoa. Within the scope of the invention, a variety of quinoa may exist in the form of strains or sub-species, and that any such strain or sub-species can be used in connection with methods, processes and products of the present invention.

In general, one process for making a quinoa-based beverage in accordance with the invention involves preparing a quinoa additive made by grinding or pulverizing quinoa beans to produce an additive or ingredient for a beverage formulation. The invention recognizes the advantages of employing a grinding process to obtain the healthful benefits of the quinoa bean in a soluble form for inclusion in a beverage formulation. The invention further identifies a range of quinoa particle sizes which are suitable for dissolving in a liquid formulation for a quinoa-containing beverage. The invention relates to a specific and essential process of grinding all natural quinoa grain, for example by a stone grinder or mechanical mill or other pulverization process or mechanism, to a specific particle size, or within a ranges of particles sizes such as for example from about 30 microns to 350 microns or larger, or preferably in a range from about 50 microns to 250 microns or larger, or more preferably in a range of from about 80 microns to about 150 microns. The ground quinoa powder is then mixed or dissolved in a liquid medium, such as a water base, to create a drinkable beverage which can be flavored in any suitable manner. The beverage is then heated to within a temperature range of approximately 180 to 212 degrees Fahrenheit for a period of at least approximately 30 seconds or longer. This performs a pasteurization of the beverage and cures the beverage formulation.

The dry grinding process enables use of quinoa of any variety and in any form to produce the quinoa powder which is blended and dissolved with the water base to create the quinoa beverage. Prior to grinding, quinoa in raw form is washed by conventional methods such as mechanical debrading, hydro-mechanical or biodegradable surfactant. The preferred range of the ground particulate size is economical for large scale production, and is readily blended without clumping.

One example of a suitable method of milling, grinding or pulverization of quinoa to within the described range of particle size is to use a commercial milling machine, such as manufactured by Retsch of Germany, which can be specified and set up to produce any target particle sizes within the prescribed range. This equipment is suitable for production of ground quinoa in commercial quantities and at rates suitable for supply of quinoa as an ingredient in large-scale bottled beverage production.

For production purposes, quinoa can be ground to the specified particle size range in bulk and packaged and shipped in such form, or transferred directly into the beverage formulation. Additives to ground quinoa can be used as fillers, preservatives, colorant and moistures absorption, i.e., anti-clumping.

An additional or alternative processing step involves roasting or otherwise heat-treating quinoa grain with forced air, heated to within an approximate temperature range of 450 to 460 degrees F., for an approximate period of 10 to 20 minutes depending upon product volume and size of the heating chamber. The roasting is performed prior to the described grinding operation, as a flavor-enhancing measure, and also to reduce the moisture content which improves efficiency of the grinding and pulverization process and avoids clumping or clogging of the milling machinery. Quinoa which is roasted can be ground or milled soon thereafter or stored in the roasted state.

The quinoa-based beverage production process can be automated and streamlined in a commercial operation for production of large inventories, to proceed from intake of quinoa in bulk, washing, drying or roasting, grinding/pulverization, mixing with the liquid base and other ingredients and bottling or other container packaging. Commercially available food and beverage processing and handling equipment is suitable for the described production process.

### Example I

A 10 kg supply of fresh washed quinoa grain is dried and mechanically ground in a milling machine to within a particle size range of 30 to 350 microns, and mixed in a volume ratio range of 2 to 20% with potable water heated to within the temperature range of 180 to 212 degrees for a period of between 20 seconds to 5 minutes. Additives, blended in by continuous stirring, include sweetener (e.g. organic sugar), other natural flavorings, colorants (e.g. vegetable juice, citric acid and preservatives.

An alternate process for producing a quinoa-containing beverage in accordance with the invention involves an extract prepared by boiling quinoa beans in water. The water is transferred from the boiled quinoa beans to an extraction apparatus, wherein the water contains a quantity of quinoa bean extract. In another embodiment the water is discarded. The boiled quinoa beans are placed into a grinder and ground to a degree that increases extraction efficiency while permitting an adequate flow rate of water through the ground beans. Hot water is then added to the ground beans thus extracting soluble components therefrom. The hot water used in this step could be either the water used to boil the whole beans, or it could be fresh water. The liquid containing the extract is collected by filtration.

In general the solid-liquid extraction process is performed using aqueous media that is capable of being consumed by humans. More particularly, the aqueous media can comprise potable water from any of a variety of acceptable sources including tap water, spring water, well water, and the like. Preferably, the water is heated prior to or during the extraction process to a temperatures in a range from about 25 degrees Celsius to about 100 degrees Celsius.

The quinoa seeds can be ground to an average particle size that enhances extraction without unduly impeding filtrate flow. Any of a variety of filtration methods can be used in connection with the process of the present invention. For instance, the filter can comprise a disposable paper filter, a reusable polymer or metallic filter, a filter basket, and the like. Furthermore, the water used for extraction can be passed through the ground quinoa in a continuous manner, i.e. so that addition of the water occurs simultaneously with draining the extract. Alternatively, the ground quinoa can be extracted in a batchwise manner, i.e. so that the water is added and held in contact with the ground quinoa while extraction occurs, and then the water is drained. Optionally, the extraction process can include agitation as a means of enhancing extraction speed or efficiency. For instance, the mixture of ground quinoa and water could be shaken, or could be sparged (i.e. receive a stream of gas that causes bubbling), or could be stirred either automatically or manually. Optionally, the filtration process can also include a means for assisting liquid flow through the ground quinoa. For instance, such a means can include a gas pressure, a vacuum, a mechanical press or plunger, and the like.

The extract of the present invention can be used or further processed in any of a variety of ways. For instance, in one embodiment the extract alone serves as a beverage. In another embodiment the extract is mixed with any of a variety of flavorings such as sweeteners, and/or natural or artificial flavors such as fruit or herbal flavors. In still another embodiment the extract is diluted with an appropriate edible substance such as water or ethyl alcohol. In still another embodiment of the present invention the extract receives a gas charge such as a charge of carbon dioxide as a means of achieving an out-gassing or bubbling action during consumption. Any of the foregoing additional processing steps can be used alone or in any combination thereof.

The foregoing examples are considered only illustrative of the principles of the invention rather than an exclusive list of embodiments. Further, since numerous modifications and changes will readily occur to those of ordinary skill in the art, the invention is not intended to be limited to the exact construction and operation shown and described, and accordingly, all suitable modifications and equivalents are within the scope of the present invention.

What is claimed is:

1. A method of making a quinoa-containing beverage, comprising the steps of:
a) grinding quinoa seeds to particles with sizes in an approximate range of 30 microns to 350 microns to create ground quinoa;
b) mixing a quantity of ground quinoa with a liquid base in an approximate volumetric ratio of 2% to 15% ground quinoa to the liquid base wherein the ground quinoa is in solution in the liquid base;
c) mixing at least one additional ingredient to the ground quinoa and liquid base mixture to form the quinoa-containing beverage, and
d) heating the quinoa-containing beverage to within an approximate temperature range of 180 degrees F. to 220 degrees F.

2. The method of claim 1 further comprising the step of washing the quinoa seeds prior to grinding.

3. The method of claim 1 further comprising the step of grinding the quinoa seeds in a milling machine.

4. The method of claim 1 further comprising the step of roasting the quinoa seeds by exposure to heated air in an approximate temperature range of 400 to 500 degrees F. of prior to grinding.

5. The method of claim 1 further comprising the step of grinding quinoa seeds to particles within the approximate particle size range of 80 microns to 150 microns.

6. The method of claim 1 wherein the step of mixing a quantity of ground quinoa with a liquid base in an approximate volumetric ratio of 2% to 15% ground quinoa to the liquid base is performed by agitation.

7. The method of claim 1 wherein the step of mixing a quantity of ground quinoa with a liquid base in an approximate volumetric ratio of 2% to 15% ground quinoa to the liquid base is performed by stirring.

8. The method of claim 1 wherein the step of mixing a quantity of ground quinoa with a liquid base in an approximate volumetric ratio of 2% to 15% ground quinoa to the liquid base is performed with application of heat to the mixture.

9. The method of claim 1 wherein the mixing of at least one additional ingredient is mixing a flavoring.

10. The method of claim 1 wherein the mixing of at least one additional ingredient is mixing a colorant.

11. The method of claim 1 wherein the mixing of at least one additional ingredient is mixing a preservative.

12. The method of claim 1 wherein the heating of the quinoa-containing beverage to within an approximate temperature range of 180 degrees F. to 220 degrees F. is performed in a batch process prior to final packaging.

13. The method of claim 1 further comprising the step of packaging the quinoa beverage in individual containers.

14. The method of claim 1 further comprising the step of dry mixing at least one additional ingredient to the ground quinoa prior to mixing of the ground quinoa with the liquid base.

15. A quinoa-containing beverage comprising:
a liquid base mixed with 2% to 15% ground quinoa by volume, the ground quinoa having a particle size in the approximate range of 30 to 350 microns, and at least one additional ingredient mixed with the liquid base and ground quinoa.

16. The quinoa-containing beverage of claim 15 wherein the at least one additional ingredient is a flavoring.

17. The quinoa-containing beverage of claim 15 wherein the at least one additional ingredient is sugar.

18. The quinoa-containing beverage of claim 15 wherein the at least one additional ingredient is a colorant.

19. The quinoa-containing beverage of claim 15 wherein the at least one additional ingredient is a carbonated liquid.

20. The quinoa-containing beverage of claim 15 in a container having a volume in an approximate range of 100 ml to 1500 ml.

21. The quinoa-containing beverage of claim 20 wherein the container is made of glass.

22. The quinoa-containing beverage of claim 20 wherein the container is a metal can.

23. The quinoa-containing beverage of claim 15 comprising ground quinoa which was roasted prior to being ground and mixed with the liquid base.

24. The method of claim 15 further comprising the step of grinding quinoa seeds to particles within the approximate particle size range of 50 microns to 250 microns or larger.

25. The method of claim 15 further comprising the step of grinding quinoa seeds to particles within the approximate particle size range of 80 microns to 150 microns or larger.

26. A process for making a quinoa bean beverage or beverage component comprising the steps of:
providing water in an amount sufficient to boil a quantity of quinoa beans;
providing the quantity of quinoa beans;
boiling the quinoa beans in the water at about 100 degrees Celsius and prevailing atmospheric pressure for a period of time from about 60 minutes to about 10 minutes;
transferring the water from the boiled quinoa beans to an extraction apparatus, wherein the water contains a quantity of quinoa bean extract;
placing the boiled quinoa beans into a grinder and grinding the quinoa beans;
extracting soluble components from the ground quinoa beans using the transferred water thus forming a beverage or beverage component, wherein the transferred water is at a temperature of from about 25 to about 100 degrees Celsius;
filtering a liquid extract from the solid residue; and collecting the liquid extract.

27. The process of claim 26 wherein the quinoa beans comprise the beans obtained from Chenopodium quinoa.

28. The process of claim 26 wherein the step of boiling is carried out over a period of from about 20 minutes to about 40 minutes.

29. The process of claim 26 wherein the water is transferred at a temperature of from about 65 to about 100 degrees Celsius.

30. The process of claim 26 wherein the step of extracting further comprises a process selected from the group consisting of a continuous flow process and a batchwise process.

31. The process of claim 26 wherein the step of extracting further comprises agitating the solid-liquid mixture by a means selected from the group consisting of sparging, shaking and stirring.

32. The process of claim 26 wherein the step of filtering further comprises filtering through a filter selected from the group consisting of a disposable paper filter, a polymer filter screen, a metallic filter screen and a filter basket.

33. The process of claim 26 wherein the filtration process further comprises assisting liquid flow by applying a pressure or vacuum.
